(19) United States
(12) Patent Application Publication
(10) Pub. No.: US 2023/0342950 A1
(43) Pub. Date: Oct. 26, 2023

(54) INFORMATION PROCESSING APPARATUS, CONTROL METHOD OF INFORMATION PROCESSING APPARATUS, AND PROGRAM RECORDING MEDIUM

(71) Applicant: CANON KABUSHIKI KAISHA, Tokyo (JP)

(72) Inventors: Kei YOSHINAGA, Kanagawa (JP); Shuhei OGAWA, Kanagawa (JP)

(21) Appl. No.: 18/302,217

(22) Filed: Apr. 18, 2023

(30) Foreign Application Priority Data
Apr. 25, 2022 (JP) 2022-071955

(51) Int. Cl. G06T 7/246; G06V 10/74; G06F 3/14

(52) U.S. Cl. CPC G06T 7/246; G06V 10/761; G06F 3/14; G06V 2201/07; G06T 2207/30196

(57) ABSTRACT

An information processing apparatus determines tracking information that is a target of collation processing for performing association with person information from among a plurality of items of tracking information corresponding to a plurality of persons detected from a video image frame based on a feature amount of each of the plurality of persons, and executes collation processing in which person information to be associated with the tracking information that is a target of the collation processing is identified based on a similarity between a feature amount of a person corresponding to a tracking information determined to be a target of the collation processing and a plurality of feature amounts stored in association with a plurality of items of person information in a storage device.

### BACKGROUND OF THE INVENTION

### Field of the Invention

The present invention relates to object tracking processing.

### Description of the Related Art

Conventionally, there is a technique for tracking a path of movement of a person in a video image captured by a surveillance camera. When a person in a video image is collated with the information for a person who is present in a database (hereinafter, referred to as “person information”) while chasing the person in the video image in real time, collation processing needs to be completed in a short period of time so that the tracking processing can be performed without delay on each frame. However, as the number of persons in the video image and the number of items of person information increase, the calculation amount of collation processing increase.

A conventional method for limiting the number of persons to be collated in a video image so as to reduce the calculation amounts when many persons in the video image are present has been disclosed. Japanese Patent application Laid-Open No. 2008-40781 discloses a method for limiting the persons to be collated based on the number of collations in the past and time-series information regarding the person who is being tracked in the video image. According to this method, for example, the correctness of personal information for an object for which a long time has passed since the most recent collation can be confirmed preferentially. Japanese Patent application Laid-Open No. 2020-9383 discloses a method for preferentially selecting a person whose location significantly changes from the previous frame, that is, a person is highly possible to frame out soon, and treating the selected person as a collation target. According to this method, even when there are many persons in the video image, the calculation amount can be reduced while preventing omission of collation processing for the persons appearing in the video image.

### SUMMARY OF THE INVENTION

The object of an information processing apparatus according to the present disclosure is reducing a calculation amount related to collation of a person in a video image.

An information processing apparatus, as one aspect of the present invention determines tracking information that is a target of collation processing for performing association with person information, from among a plurality of items of tracking information corresponding to a plurality of persons detected from a video image frame, based on a feature amount of each of the plurality of persons, and executes collation processing in which person information to be associated with the tracking information that is a target of the collation processing is identified based on a similarity between a feature amount of a person corresponding to a tracking information determined to be a target of the collation processing and a plurality of feature amounts stored in association with a plurality of items of person information in a storage device.

Further features of the present invention will become apparent from the following description of exemplary embodiments with reference to the attached drawings.

### BRIEF DESCRIPTION OF THE DRAWINGS

FIG. 1 is a diagram showing an information processing apparatus in an embodiment.

FIG. 2 is a block diagram of a functional configuration of the embodiment.

FIG. 3A and FIG. 3B are processing flow charts in the embodiment.

FIG. 4 is a diagram explaining video images handled in the embodiment.

FIG. 5A and FIG. 5B are diagrams explaining information stored in a storage unit according to the embodiment.

FIG. 6A and FIG. 6B are diagrams explaining the processing of a combination determination unit 270 in the embodiment.

FIG. 7 is a diagram explaining the processing of a person collation unit in the embodiment.

FIG. 8 is a block diagram of the functional configuration in the embodiment.

FIG. 9 is a processing flow chart of the embodiment.

FIG. 10 is a diagram explaining information generated by a narrowing unit in the embodiment.

FIG. 11 is a diagram explaining a video image handled in a modified example of the embodiment.

### DESCRIPTION OF THE EMBODIMENTS

A detailed description of a mode for carrying out the present invention will be explained below with reference to the attached drawings. The embodiment described below is an example of a means of executing the present invention and should be modified or changed as appropriate depending on the configuration of the apparatus to which the present invention is applied and various conditions, and the present invention is not limited to the embodiments below. Additionally, the configuration may be made by appropriately combing a part of each of the embodiments to be described below.

An information processing apparatus 100 according to the present embodiment also functions as a person tracking apparatus that analyzes video images in which a person shot by a network camera and the like stands out and acquires a path of movement of the person. In the present embodiment, an example of acquiring the path of movement of the same person from a single camera video image will be explained.

First, processing of following the path of movement of a person treated in the present embodiment will be explained below. In the present embodiment, the process of following the path of a short-time movement of a person is referred to as “tracking”. Hereinafter, information on the path of movement obtained by tracking processing is referred as “tracking information”. Tracking information is information in which a person is detected for each frame in a video image and items of information for a person detection range in each frame are connected in time series. Hereinafter, the information regarding the detection regions in which the items of tracking information are connected is referred to as a “feature amount”. The feature amount is the coordinates of the detection region and image features.

Additionally, hereinafter, the processing of associating tracking information on the same person is referred to as “person collation”. In the present embodiment, the association is performed by associating a plurality of items of tracking information considered to be the path of movement of the same person by using an ID of a person that is present in the database. Additionally, hereinafter, the ID that associates a plurality of items of tracking information is referred to as “person information”. When a person in the video image reappears after disappearing from a screen for a long time during the tracking processing and then appears again, the tracking information is interrupted. However, when a person collation is performed, the moving path of the tracking information, which has been interrupted before and after a person disappears, is associated as the path of movement of the same person.

The tracking information includes the tracking information in which the person information has not been determined and the tracking information in which the person information has been determined (first tracking information). Note that from among the items of the tracking information, the tracking information in which the person information has not been determined will be referred to below as “tracking information query (second tracking information)” so as to distinguish from the tracking information in which the person information has been determined. Additionally, person information includes person information (first person information) in which associated tracking information is present in a frame being processed and person information in which associated tracking information is not present in the frame being processed. Note that, hereinafter, the person information in which the associated tracking information is not present in the frame being processed, from among the items of the person information, will be referred to as “person information in which collation has not been established (second person information)”.

In addition, in the present embodiment, an explanation will be given of a method for determining, as a collation object, a combination of tracking information and person information in which the probability of determining the person information corresponding to a tracking information query is high, from among tracking information query and person information. In the following, there are cases in which the combination of the collation target of the tracking information and the person information is referred to as a “combination of collation target”.

In the present embodiment, an index referred to as a degree of confirmation, which indicates the probability that the person information corresponding to the tracking information query is be determined, is calculated using the tracking information, and a combination of collation targets is determined based on the degree of confirmation. Additionally, in the present embodiment, when there is a plurality of tracking information queries, the feature amount in the most recent frame and the feature amount in the past frame held in tracking information queries are compared, and the tracking information query in which the feature amounts change significantly is included in the combination of collation target.

The past frame is a frame that has been processed earlier than the frame being processed, and, in the present embodiment, the past frame is one frame earlier than the frame that has been acquired most recently. By treating only the tracking information query in which the feature amounts change significantly as a collation target, the tracking information query corresponding to a person whose appearance does not change significantly with respect to the past frame is determined not to be able to confirm the person information even if the person collation is performed again, and the processing of the person collation is omitted.

In the procedure, first, a person is detected for each frame of the video image, and tracking information obtained by tracking the person over a plurality of frames is generated. Next, with the object of performing person collation, the degree of confirmation is determined for each query of the tracking information based on the tracking information. Specifically, the degree of confirmation is determined for each tracking information query based on a difference in the feature amount (change amount) in the tracking information query. Then, a combination of the tracking information and person information with a high degree of confirmation is determined to be a collation target, from among the items of the person information that have not been collated with the tracking information query based on the degree of confirmation. Finally, a person collation is performed with the combinations of collation target as an object.

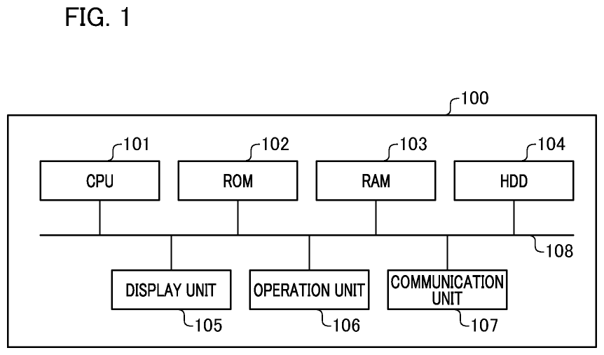

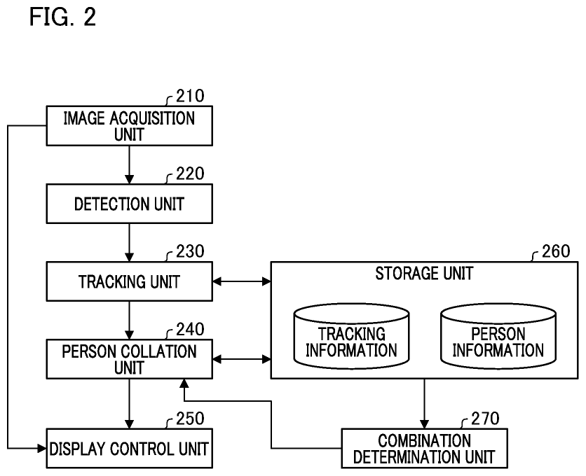

Next, a configuration of the information processing apparatus 100 in the present embodiment will be explained with reference to FIG. 1 and FIG. 2. FIG. 1 is a diagram of one example showing the hardware configuration of the information processing apparatus 100 according to the present embodiment.

As shown in FIG. 1, the information processing apparatus 100 in the present embodiment has a CPU 101, a ROM 102, a RAM 103, an HDD 104, a display unit 105, an operation unit 106, and a communication unit 107.

The central processing unit (CPU) 101 is a central calculation unit configured by at least one computer, performs calculations, logical decisions, and the like for various processes, and controls each configuration component connected to a system bus 108. The Read-Only Memory (ROM) 102 is a program memory and stores programs for control performed by the CPU 101 including various processing procedures to be described below. The Random Access Memory (RAM) 103 is used as a main memory of the CPU 101 and temporary storage regions such as a work area and the like. Furthermore, the program memory may be realized by loading a program into the RAM 103 from an external storage device and the like connected to the information processing apparatus 100.

The HDD 104 is a hard disk for storing electronic data and programs according to the present embodiment. An external storage device may be used as a device that plays a similar role. Here, the external storage device can be realized by, for example, a medium (recording medium) and an external storage drive for realizing access to the medium. For example, flexible discs (FD), CD-ROMs, DVDs, USB memories, MOs, flash memories, and the like are known as such media. Additionally, the external storage device may be a server device and the like connected by a network.

The display unit 105 is, for example, a CRT display, a liquid crystal display, and the others, and is a device that outputs images to a display screen. Note that the display unit 105 may be configured by an external device connected to the information processing apparatus 100 by wire or wireless. The operation unit 106 has a keyboard and a mouse and receives various types of operations by users. The communication unit 107 performs wired or wireless two-way communication with other information processing devices, communication devices, external storage devices, and the others, by using well-known communication technology.

FIG. 2 is an example of a block diagram showing the functional configuration of the information processing apparatus 100 according to the present embodiment. Each of these functional units is realized by the CPU 101 deploying a program stored in the ROM 102 to the RAM 103 and executing processing according to each of flow charts to be described below. In addition, execution results of each of the processes are then held in the RAM 103 or the HDD 104. Additionally, for example, in the case in which hardware is configured as an alternative to software processing using the CPU 101, it is sufficient if the operation unit and circuit corresponding to the processing of each functional unit described here are configured.

As shown in FIG. 2, the information processing apparatus 100 in the present embodiment has an image acquisition unit 210, a detection unit 220, a tracking unit 230, a person collation unit 240, a display control unit 250, a storage unit 260, and the combination determination unit 270.

The image acquisition unit 210 acquires an video image or a series of images to be processed from an external device in the order of time series. In addition, the image acquisition unit 210 also acquires a frame that has been cut from the acquired video image. Note that the image acquisition unit 210 also functions as an acquisition means for carrying out each of the processes described above. Details of the processing that the image acquisition unit (acquisition means) 210 performs will be described below.

The detection unit 220 acquires one frame in the video image that is a processing target acquired by the image acquisition unit 210, and detects a person from the acquired frame. Additionally, the detection unit 220 transmits information on regions (detection regions) surrounding all detected persons to the tracking unit 230. Details of the processing that the detection unit (detection means) 220 performs will be described below. The tracking unit (tracking means) 230 performs processing (tracking processing) for tracking a person in the video image based on the information acquired from the detection unit 220. Details of the processing that the tracking unit 230 performs will be described below.

The person collation unit 240 acquires a tracking information query and person information in which collation has not been established from the combination determination unit 270, and performs a person collation based on these items of the information. The display control unit 250 causes the display unit 105 to display at least one of the tracking information and the person for each frame in the video image displayed on the screen. Details of the processing that the person collation unit (collation means) 240 performs will be described below.

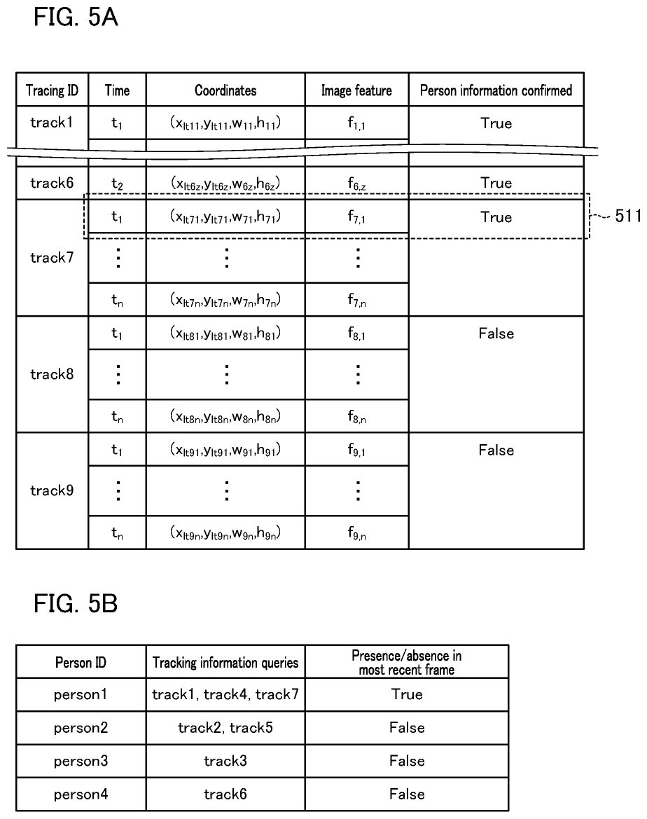

The storage unit 260 stores a plurality of items of tracking information and person information. Additionally, the storage unit manages databases related to tracking information, person information, and the like as shown in FIG. 5 to be described below. Details of the processing that the storage unit (storage means) 260 performs will be described below.

The combination determination unit 270 calculates a degree of confirmation based on a tracking information query and person information in which collation has not been established, and based on the tracking information, determines a combination with a high degree of confirmation based on the degree of confirmation. Details of the processing that the combination determination unit (decision means) 270 performs will be described below.

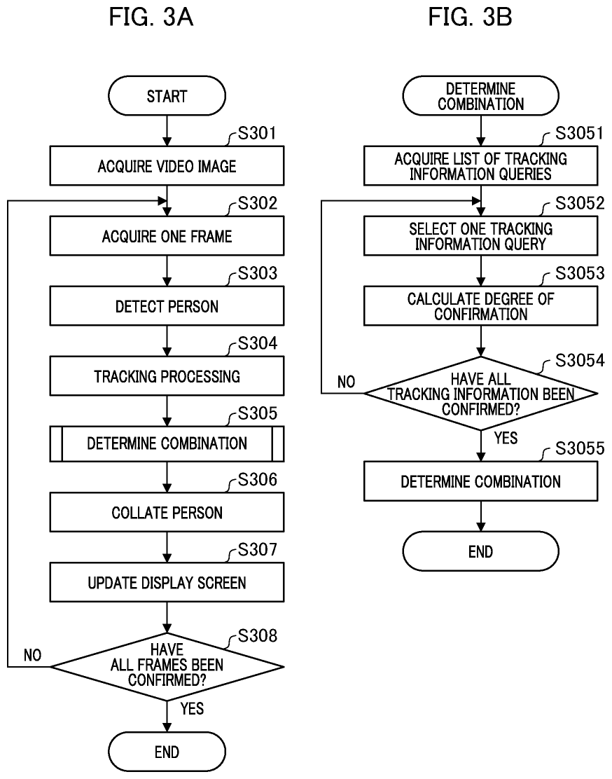

Hereinafter, the contents of processing of each functional unit (each means) described above in the present embodiment will be explained in detail with reference to FIG. 3. FIG. 3 is a flow chart that explains the processing of the information processing apparatus 100 in the present embodiment. In the explanation below, with respect to each process (step), the notation of “process (step)” will be omitted by placing S at the beginning. FIG. 3A is a flowchart showing the process in the fourth embodiment. FIG. 3B is a flow chart showing details of the processing in S305 in FIG. 3A. Furthermore, each operation (processes) shown in the flow chart in FIG. 3 is controlled by the CPU 101 executing a computer program, as described above.

First, in S301, an image acquisition unit 210 acquires video images or a series of images to be processed from an external device in the order of time-series. Although the external device that acquires the images is, for example, an imaging device including a camera and the like, it is not limited to the camera and may be a device including a server or a device stored in a storage medium, for example, an external memory. Additionally, the external device may have a built-in camera or acquire images from a remote camera via a network, for example, an IP network.

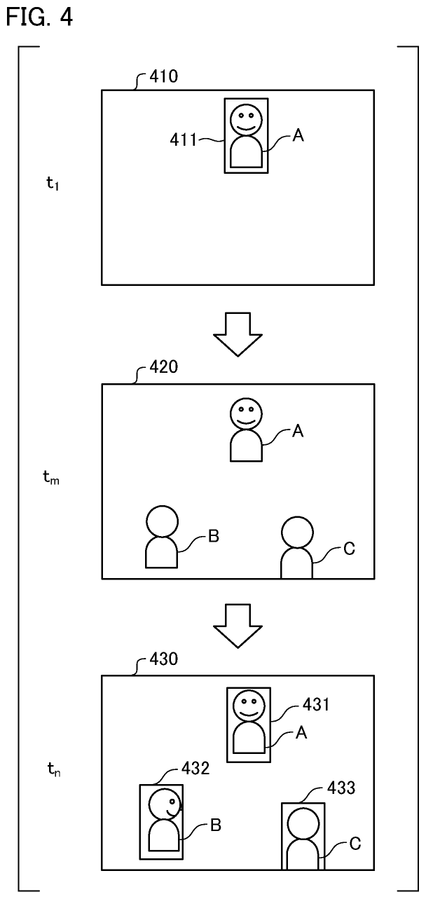

In the present embodiment, the image acquisition unit 210 acquires a frame (frame image) cut from the video image shown in FIG. 4. The video image in the present embodiment is configured by a plurality of frames. In the explanation of the embodiment, video images from time t₁ to time tₙ shown in FIG. 4 are targeted. However, it is assumed that the processing for following the path of movement of a person in the video image is performed on the video image captured in advance earlier than time t₁. Additionally, it is assumed that a plurality of items of tracking information and person information has already been stored in the storage unit 260.

FIG. 4 is a diagram that explains video images used in the present embodiment. An image 410 is a frame at time t₁. An image 420 is a frame at time tₘ. An image 430 is a frame at time tₙ. In the video image shown in FIG. 4, at time t₁, only the person A who faces the front is captured in the video image, and at time tₘ that is later than time t₁, a person B and a person C who turn backward are framed in. In this case, it is assumed that the clothes of person B and the person C are similar. At the time tₙ that is later than time tₘ, the person B faces sideways.

Since the person A is facing forward since time t₁ and his/her face is clearly visible, there is a high probability that the corresponding person information can be determined by a person collation. That is, the person A is in a state in which the corresponding person information can be easily determined by a person collation. In contrast, since the person B and the person C are both turn backward from time tₘ until just before time tₙ, they are in a state in which the person information is difficult to be determined. Therefore, there is a low probability that the personal information on the persons B and the person C can be determined at time tₘ. However, at time tₙ, since the person B turns sideways, a face that is unique information for each person is reflected in the frame. Accordingly, there is a high probability that the person information on the person B can be determined. In the present embodiment, using such a video image as an example, the person collation is performed only on the person whose appearance in the detection region has significantly changed from the previous frame, from among the persons corresponding to the tracking information query in which the person information has not been determined. In contrast, regarding a person whose appearance in the detection region changes little from the previous frame, it is determined that the probability that the person information is determined is low even if the person collation is performed again, and the person collation is omitted.

Referring back to FIG. 3, next, in S302, the detection unit 220 acquires one frame in the video image to be processed acquired by the image acquisition unit 210.

Next, in S303, the detection unit 220 performs processing for detecting a person from the frame. Specifically, the detection unit 220 acquires frames from video images that have been acquired from the image acquisition unit 210, performs detection processing on each frame, and acquires position information on the person within the frame. In the present embodiment, detection is performed by a model for which learning for detecting a person from an image has been previously performed. For example, learning of many learning data configured from a pair of an image of a person and correct images showing the position of the person in the image is performed, a frame is input to the model, and consequently, output of information on the position of the person within the frame becomes possible. Any machine learning algorithm may be used for learning of the model of the present embodiment, for example, algorithms such as a neural network can be used.

In the present embodiment, it is assumed that information on the detection region for each person within the frame is acquired to be used as the information on the position obtained by the detection unit 220. The information on the detection region here is the coordinates of the upper left edge and the size of the detection region in the frame. The rectangular-shaped detection region 411 of the image 410 in FIG. 4 is an image of a detection region for a person (person region). After detecting the information on the detection regions with respect to all persons in the frame, the detection unit 220 transmits (outputs) the detected information to the tracking unit 230. In the following, for the simplicity of the explanation, the processing for the frame at time tₙ will be described.

Next, in S304, the tracking unit 230 performs processing for tracking the person in the video image (tracking processing). Specifically, in the tracking processing in the tracking unit 230, generation or update of the tracking information is performed by assigning information on the detected region for each person in each frame to different items of tracking information for each person. The tracking information is information in which the feature amounts related to the detection region for each frame of the person being tracked are connected by the number of frames in which the person has been detected, as described above.

In the present embodiment, the tracking unit 230 receives information on each detection region from the detection unit 220, and assigns the information on each detection region of the most recent frame at that point in time to the tracking information of the previous frames as a feature amount. These items of information are used for assignment processing that the tracking unit 230 performs will be described below. When there is a high probability that the person in the detection region within the frame is a person who is present in the proceeding frame (past frame), the tracking unit 230 adds a feature amount related to the detection region of the most recent frame to the tracking information on that same person. Additionally, when it is recognized that a new person has appeared, the tracking unit 230 generates new tracking information.

The assignment processing performed by the tracking unit 230 is performed by comparing the feature amount in the detection region of the person in the most recent frame and the feature amount stored in the tracking information generated for the previous frames has. Specifically, the similarity of the feature amounts in the detection region of each person in the previous frame is checked against the feature amounts in the detection region of each person in the most recent frame. In addition, the feature amount of the most recent frame is added to the tracking information having the highest similarity to the previous state. For example, when the position information (coordinates) of a detection region is used as a feature amount, the central position of the detection region can be used. Additionally, when image features are used, feature amounts that are acquired by applying color information, texture information, convolutional neural networks (CNN), and the like in the detection region of the frame to the detection region can be used. In the present embodiment, the tracking information generated by the tracking unit 230 is transmitted to the storage unit 260, and the transmitted tracking information is managed by the storage unit 260.

FIG. 5 is a diagram that explains the information that is stored in the storage unit 260 according to the present embodiment. FIG. 5A is a diagram showing an example of a tracking information database managed by the storage unit 260. In the example shown in FIG. 5A, it is assumed that IDs that distinguish the tracking information to be stored in the storage unit 260 are tracking IDs.

Additionally, the storage unit 260 manages the time of the frame in which a person has been detected, the coordinates and size of the detection region, image features, and the like, as a set for each of the tracking IDs, as shown in FIG. 5A. Here, in the present embodiment, it is assumed that the tracking information in which the tracking IDs are track 1 to track6 is information stored by performing processing on another image before processing on the video image as shown in FIG. 4 is performed.

The tracking information in which the tracking IDs are track 7, track 8, and track 9 is assumed to be the path of movement of the person A, the person B and the person C in the video image as shown in FIG. 4. For example, the coordinates shown by a dotted line region 511 indicate the coordinates of the detection region 411 at time t₁ of the person A in the image 410. The image feature is a vector of image feature acquired from a detection region. For example, the image feature f_{7,1} is a vector of image feature acquired from the detection region 411.

To simplify the description, the tracking information of track 7 in the tracking ID is referred to as “tracking information track 7”, and the tracking information query of track 8 and track 9 in the tracking ID is referred to as “tracking information query track 8 and the tracking information query track 9”. Additionally, information indicating whether or not the person information corresponding to the tracking information has been determined is set in the column of “Person information determined” in the database as shown in FIG. 5A. In the database example as shown in FIG. 5A, “True” indicates that the person information for the tracking information has been determined. “False” indicates that the person information that corresponds to the tracking information has not been determined and is remains pending. The tracking information indicated as “False” is a tracking information query in which a person collation needs to be performed in the future. The tracking information in which the element of “Person information determined” is “False” includes tracking information that has immediately been generated (in which person collation has never been performed) and tracking information in which person information has not been determined although person collation has been performed in the past.

Next, in S305, based on the tracking information, the combination determination unit 270 determines a combination with a high degree of confirmation based on the tracking information query and person information in which collation has not been established. The detailed processing content of the combination determination unit 270 will be explained below using the flow chart in FIG. 3B. FIG. 3B is a flow chart showing the details of the processing of the combination determination unit 270 in S305.

First, in S3051, the combination determination unit 270 obtains lists of tracking information queries. That is, the combination determination unit 270 obtains lists only of the number of tracking information queries. In this case, the combination determination unit 270 acquires information on the tracking information query track 8 and the tracking information query track 9 from the storage unit 260, as an example of the list.

Next, in S3052, one tracking information query is selected from the lists acquired in S3051. In this case, the tracking information query track8 is selected as an example. Hereinafter, a tracking information query selected in S3052 will be referred to as “tracking information query that is the focus of attention”.

Next, in S3053, the combination determination unit 270 calculates the degree of confirmation based on the tracking information. In the present embodiment, the combination determination unit 270 determines the degree of confirmation based on a comparison between feature amounts in the tracking information query. Specifically, the degree of confirmation is determined based on a distance in data space between the feature amount in the most recent frame and the feature amount in the past frame(s). Here, the degree of confirmation is a value of the difference (amount of change) between the feature amount in the most recent frame and the feature amount in one previous frame in the tracking information query.

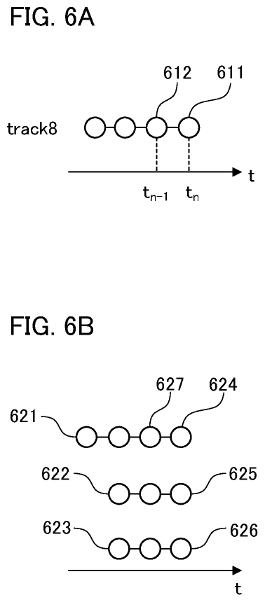

FIG. 6 is a diagram that explains the processing of the combination determination unit 270 in the present embodiment. FIG. 6A is an image diagram of the tracking information query track8 that corresponds to the person B. FIG. 6B is an image diagram for explaining how the degree of confirmation is determined. The circle marks in FIG. 6 are the feature amounts of the detection region of one person within one frame, and the feature amounts are arranged according to time series. Here, the difference between a feature amount 611 and a feature amount 612 at time tₙ that is the most recent and time tₙ₋₁ that is one previous time is calculated for each of the tracking information queries.

For example, it is assumed that the difference in the feature amount of the tracking information query track8 is 20,000. In this case, the combination determination unit 270 determines (calculates) 20,000 that is the difference in the feature amount of the tracking information query track8, as the degree of confirmation of the tracking information query track8.

Next, in S3054, it is determined whether or not the degree of confirmation has been calculated with respect to all the acquired tracking information queries, in S3051. When the degree of confirmation is not calculated based on all the acquired tracking information queries, the process returns to S3051, and processes as in the above description are repeated. In contrast, when the degree of confirmation is calculated based on all the acquired tracking information queries, the process proceeds to S3055.

In the case of “NO” in S3054, when the process returns to S3051, the combination determination unit 270 selects the tracking information query track9. Subsequently, the combination determination unit 270 calculates the degree of confirmation based on the tracking information. At this time, when the difference in the feature amount of the tracking information query track9 is 700, 700, which is the difference in this feature amount, is determined (calculated) to be the degree of confirmation of the tracking information query track9.

The reason why the degree of confirmation in the tracking information query track8 is greater than that in the tracking information query track9 is that, as described above, at time tₙ₋₁, the person B and the person C turn backward, but at time tₙ, only the person B turns sideways. That is, since the behavior and the like of the person B significantly changes from time tₙ₋₁ to time tₙ, the amount of change in the tracking information query track8 that corresponds to the person B is greater. Note that, in calculating the degree of confirmation, a distance, for example, Euclidean distance between the feature amounts may be used, in addition to the difference between the feature amounts. Even if the distance, for example, Euclidean distance between the feature amounts is used, similar processing can be achieved.

Next, in S3055, based on the calculated degree of confirmation, the combination determination unit 270 performs processing for determining the combination of collation target based on the tracking information query and the person information stored in the storage unit 260 and for which collation has not been established. Specifically, tracking information queries with the degree of confirmation higher than a threshold are included in the combination of collation target.

For example, the degree of confirmation of the tracking information query track8 is 20,000 when a threshold is set to 10,000, and accordingly, the degree of confirmation of the tracking information query track8 is the threshold value or above. Hence, the combination determination unit 270 includes the tracking information query track8 in the collation target. In contrast, since the degree of confirmation of the tracking information query track9 is 700, the degree of confirmation of the tracking information query track9 is less than the threshold. Therefore, since the difference in the feature amount from the previous frame is small, the combination determination unit 270 determines that the result will not change even if the person collation is performed again, and does not include the tracking information query track9 in the collation target. Person information to be included in the combination of collation target is determined by referring to the database related to person information in the storage unit 260. Note that the threshold is set in advance, for example, before the start of the processing as shown in FIG. 3 or before the acquisition of video image as shown in FIG. 4. Additionally, the value of the threshold value can be set arbitrarily, and a user can input or change the value of threshold by operating the operation unit 106 and the like.

In the present embodiment, the tracking information query track8 that is equal to or above the threshold and all the person information in which collation has not been established is included in the collation target. Additionally, the tracking information queries that are less than the above thresholds are not included in the above collation target. In the present embodiment, it is possible to omit the processing of person collation of the tracking information query and the person information in which the possibility of determining the person is low, by limiting the combination of collation target as described above.

Here, a database related to person information that the storage unit 260 stores at the at time tₙ will be explained with reference to FIG. 5B. As described above, in the present embodiment, it is assumed that a series of processes is performed to trace the path of movement on video images on which a plurality of persons is appeared before the video image as shown in FIG. 4 are acquired. Furthermore, it is assumed that tracking information track1 to tracking information track6 are generated before the video images as shown in FIG. 4 are acquired. As shown in the row of the person IDs of the person information in FIG. 5B, it is assumed that the storage unit 260 has stored the person IDs of personal information of person 1 to person 4, which are used as person information corresponding to the person who has already appeared in the video image. Additionally, it is assumed that correspondence with one or more items of the tracking information has been determined in the past for each of person information.

Hereinafter, the case in which there is tracking information in which the correspondence to the person information has been determined prior to the most recent frame will be described as “tracking information and person information are associated”. For example, the person information person1 as shown in FIG. 5B is associated with tracking information track1, track4, and track7.

Additionally, in the present embodiment, person information has information indicating whether or not associated tracking information is present in the most recent frame. In the example of FIG. 5B, when the associated tracking information is present in the element of column of “Presence or absence in the most recent frame” in each of person IDs, “True” is indicated. Furthermore, when the associated tracking information is not present in the element of column of “Presence or absence in the most recent frame” in each of the person IDs, “False” is indicated. For example, the person A in the video image as shown in FIG. 4 has already been determined as person information person1 that corresponds to the tracking information track7. Therefore, in FIG. 5B, the element of “Presence or absence in the most recent frame” related to the person information person1 is “True”. In contrast, the person information of person2, person3, and person4 in which the element of “Presence or absence in the most recent frame” is “False” is the person information in which the corresponding tracking information is not present in the frame being processed, that is, person information that has not been collated.

Referring back to FIG. 3, next, in S306, the person collation unit 240 performs person collation processing. The person collation unit 240 obtains the tracking information query and the person information in which collation has not been established from the combination determination unit 270, and performs a person collation. A tracking information query and person information in which collation has not been established are collectively referred to as combination information of collation target. Specifically, the person collation is performed based on the similarity between the feature amount of the tracking information query and the feature amount of the tracking information associated with the person information.

For example, in the present embodiment, the degree of similarity of feature amount is calculated with respect to all the combinations of all feature amounts of the tracking information queries and all the feature amounts of the tracking information associated with person information. Then, when there is person information in which the average of the degree of similarity exceeds a predetermined threshold (predetermined value), person information corresponding to the tracking information query is determined. Formula 1 below shows an example of the formula for calculating the average of degree of similarity for person collation of one tracking information query and one item of person information.

$$\begin{matrix}[ Formula 1 ] & \\ {similarity}_{mean} = \frac{{\sum }_{ti = 1}^{tn} {\sum }_{fi = 1}^{fn ( ti )} {\sum }_{qi = 1}^{qfn} F ( {f}_{qfi} , {f}_{fi} )}{{\sum }_{ti = 1}^{tn} ( fn ( ti ) \cdot qfn )} & ( 1 )\end{matrix}$$

However, it is assumed that similarityₘₑₐₙ shown in the above Formula 1 is the average of the degree of similarity. The denominator is the total number of combinations of the feature amount that the tracking information has and the feature amount that the tracking information associated with all person information of collation target has. The numerator is the sum of the results obtained by calculating the degree of similarity in each combination thereof.

The meaning of each variable will be explained below. First, it is assumed that “tn” denotes the number of items of tracking information associated with person information, and “ti” denotes a variable that varies from 1 to th for each item of the tracking information associated with the person information. “fn (ti)” denotes an array of the number of feature amounts that each item of tracking information associated with the person information has, and has different values for each item of the tracking information. It is assumed that “fi” denotes a variable that changes from 1 to fn (ti) for each feature amount that the tracking information associated with the person information has. It is assumed that “qfn” denotes the number of feature amounts of the tracking information query, and “qfi” denotes a variable that changes from 1 to qfn for each feature amount of the tracking information query. It is assumed that “f” denotes a vector of feature amount. It is assumed that “F” denotes a function for calculating the degree of similarity between feature amounts. An example of the formula for the function F will be shown in Formula 2 below.

$$\begin{matrix}[ Formula 2 ] & \\ F ( {f}_{1} , {f}_{2} ) = \frac{{\sum }_{k = 1}^{nk} {f}_{1 k} \cdot {f}_{2 k}}{\sqrt{{\sum }_{k = 1}^{nk} {f}_{1 k}^{2}} \cdot \sqrt{{\sum }_{k = 1}^{nk} {f}_{2 k}^{2}}} & ( 2 )\end{matrix}$$

However, it is assumed that f denotes a vector of one feature amount, and f₁ and f₂ are different vectors having the length of nk. It is assumed that “k” denotes a variable that varies from 1 to nk for each feature amount.

When person collation is performed, the degree of similarity is calculated by the number of times corresponding to the number of combinations of the feature amount that the tracking information has and the feature amount that the tracking information associated with each item of person information has, as shown in the above Formula 1. Hence, when the number of times of person collation increases, the amount of calculation becomes more demanding. Therefore, the object of the present embodiment is reducing the calculation amount by limiting tracking information queries of the collated target based on the degree of confirmation.

In the present embodiment, as described above, the tracking information query track8 is a collation target to the person information, and the tracking information query track9 is not the collation target to the person information. Accordingly, the person collation processing in which the combination of the tracking information query track8 and person information of person2, person3, and person4 are targeted will be explained below.

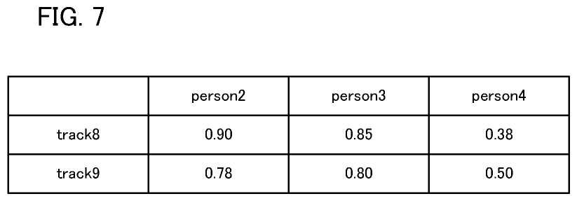

FIG. 7 is a diagram that explains one example of the processing performed by the person collation unit 240 in the present embodiment. Note that, in the present embodiment, it is assumed that the threshold at this time is set to “0.9.”. Note that the threshold value is set in advance before the start of the processing shown in FIG. 3 or before the acquisition of image in FIG. 4. Additionally, the value of the threshold can be set arbitrarily, and a user can input or change the value of the threshold by operating the operation unit 106 and the like.

As shown in FIG. 7, since the degree of similarity in the combination of the tracking information query track8 and the person information person 2 is “0.90”, this is equal to the threshold or above. Accordingly, the person information person 2 is determined to correspond to the tracking information query track8. When the person information is determined to correspond to the tracking information query, the storage unit 260 updates the database of the tracking information and regarding person information. Specifically, the cell in the column of “person information determined” of the tracking information query track8 in the table in FIG. 5A is rewritten from “False” to “True”. Additionally, the tracking information query track8 is added to the column of the tracking information query in the row of the person information person2 in the table in FIG. 5A, and in the element in the column of “Presence or absence in the most recent frame”, the element is rewritten to “True”.

In contrast, with regard to the query track9 of the tracking information that has not been selected to be the collation target (that has not been included in the collation target), the element in the column of “Person information determined” in the database of the tracking information in FIG. 5A is not rewritten from “False”. That is, with regard to the tracking information query track9, the person information has not been able to be determined and remains pending.

Next, in S307, the display control unit 250 updates the display screen of the display unit 105. The display control unit 250 outputs at least one item of the tracking information or the person information for each frame in the video image. Specifically, the display control unit 250 causes a frame of the detection area as shown in FIG. 5 to be displayed in the peripheral region of the person in the frame, and further causes the tracking ID and person ID to be displayed around the frame. Note that the display control unit 250 may cause a frame to be displayed with any color on the screen of the display unit 105. For example, taking an image 430 at time tₙ in FIG. 4 as an example, the display control unit 250 can cause each of a frame 431, a frame 432 and a frame 433, which are the detection regions of each person, to be colored with the same color or different colors, and displayed on the screen of the display unit 105.

Furthermore, the display control unit 250 may add and output numerical values of information related to the person being displayed, such as a tracking ID, or a person ID, to the vicinity of each frame. In addition, the frame may be displayed in different colors according to differences in the tracking ID and the person ID. Note that the display control unit 250 may cause what is displayed on the display unit 105 to be only the frame of the detection region on the screen, or may cause the tracking ID and the person ID to be displayed without displaying the frame. Furthermore, the colors of the frames to be displayed may be unified. Furthermore, the thickness of the frame may be changed according to differences in the tracking ID and the person ID.

Next, in S308, the CPU 101 determines whether or not a series of processes has been completed with respect to all the frames in the video image. As the result of determination, when a series of processes has been completed for all the frames in the video image, processing ends. In contrast, when a series of processes has not been completed for all the frames in the video image, the process returns to S302, and processes from S302 to S308 are repeated.

According to the method as described above, in the processing of tracing the path of movement of persons in the video image, it is possible to determine a combination in which a degree of confirmation is high from among of items of tracking information and person information, and perform a person collation. According to the present embodiment, since the person collation can be omitted for the tracking information in which the possibility of determining the person information is low, the number of times of person collation can be reduced, and the calculation amount can be reduced.

If the method and processing in the present embodiment are not performed, a calculation amount corresponding to the total number of the combinations of the tracking information query and the person information in which collation has not been established occurs. However, according to the information processing apparatus 100 in the present embodiment, it is possible to suppress high-cost calculation due to a person collation. In the present embodiment, due to the amount of calculation by the processing of the combination determination section 270 increasing, the benefit of the reduction in the amount of calculation due to the reduction in the number of person collations exceeds the increase.

In the present embodiment, all items of the person information in which collation has not been established are used for person collation. As describe above, an explanation regarding the database of person information that the storage unit 260 stores at the point in time of time tₙ has been given. Specifically, in the present embodiment, the combination determination unit 270 sets the combinations of the tracking information query track8 and all the person information of person2, person3, and person4 in which collation has not been established, to a collation target.

According to the above method, the combination determination unit 270 can determine the combination of tracking information and person information in which the probability of determining the person information for the tracking information query is high, from among the tracking information queries and person information in which collation that has not been established.

Note that, the processing order of the information processing apparatus 100 in the present embodiment is not limited to the order of processing as shown in FIG. 3. Although it has been explained above that the tracking unit 230 acquires image features (feature amounts) from the detection region of a person in each frame and generates and updates the tracking information, extraction of image features is not necessarily performed for all the frames. Specifically, image features are extracted from the information on the most recent detection region of the tracking information included in the combination of collation targets. In contrast, image features are not extracted from the information on the most recent detection region of the tracking information that is not included in the combination of collation targets. According to this method, the number of times of feature extraction can also be reduced, and consequently, efficiency is better.

Note that although it has been explained above that the storage unit 260 stores the tracking information and the person information, old information may be deleted. For example, when the number of feature amounts that the tracking information has exceeds a predetermined number, the old feature amounts are deleted so that the number of feature amounts does not exceed a predetermined number. An increase in memory load can be avoided by deleting old data.

Note that although it has been described above that the past frame used when the combination determination unit 270 calculates the degree of confirmation is one previous frame, the past frame may be a frame several framers earlier. For example, when a video image captured at a high frame rate is to be processed, since there is no significant changes in the video image for each frame, a difference in the image feature between a person whose appearance changes and a person whose appearance does not change becomes more clear by using a frame several frames earlier. Note that a user or others can arbitrarily set which frame is to be used for the past frame in the calculation of the degree of confirmation.

Note that although it has been described above that the combination determiner 270 determines the degree of confirmation by the method based on a distance in the data space, there are other methods based on the degree of similarity between the feature amount in the tracking information query. Specifically, the degree of similarity between the feature amount in the most recent frame of the tracking information query and the feature amount in the past frame is calculated, and the degree of confirmation is determined based on the degree of similarity.

For example, the past frame in this case is made one previous frame. In the example of FIG. 6A, the degree of similarity between the feature amount 611 that is the most recent feature amount of the tracking information query track 8 and the feature amount 612 that is one previous amount of the feature amount 611 of the tracking information query track 8 is calculated. The degree of similarity is calculated by Formula 3 as shown in the following.

[Formula 3]

similarity_{self}=F(f_{self_latest}, f_{self_latest-1}) (3)

However, it is assumed that similarity self in the above Formula 3 is the degree of similarity between feature amounts in the tracking information queries. Function F is the same function as the formula shown in the above Formula 2. It is assumed that f_{self_latest} latest denotes the most recent feature amount of the tracking information query being paid attention to and f_{self_latest-1} denotes the feature amount that is one older than the most recent feature amount. It is assumed that the degree of confirmation is, for example, a value obtained by subtracting the degree of similarity of similarity_{self} from 1. By calculating the degree of confirmation by using this method, it is possible to omit collation processing for the tracking information query in which there is no significant change in the appearance on the image after the previous time, as in the present embodiment.

Additionally, the number of past frames used in the method based on the degree of similarity among feature amounts in the tracking information query is not limited to one, and may be two or more. Specifically, all frames of the tracking information query, a predetermined number of frames, or frames selected every few frames can be used as past frames.

For example, the degree of similarity between the feature amounts to the frame being processed is calculated for each of the past frames by the above Formula 2. Then, the maximum value is acquired from among the plurality of calculated degrees of similarity, and the value obtained by subtracting the maximum value of the degree of similarity from 1 is used a the degree of confirmation. According to this method, the person collation can be omitted when at least one of the feature quantities of the tracking information in which the person information has not been determined in the past frame is similar.

Note that in the above description, although it has been described that the combination determination unit 270 calculates the degree of confirmation based on the comparison between the feature amounts in the tracking information queries, the degree of confirmation can also be determined based on the comparison of the feature amounts between the tracking information queries. Specifically, the degree of confirmation is determined based on the degree of similarity between the query of tracking information being paid attention to and the query of other tracking information. When the degree of similarity is low, it is interpreted that there is a probability that feature amounts unique to each person, such as a face, are clearly reflected in the frame, and the degree of confirmation of query of the tracking information being paid attention to is made increase.

For example, when persons wearing similar clothing turn backward, the similarity of image features between persons becomes high, however, when at least one person turns sideways, the similarity of the appearance on the image relative to the other persons becomes low. The method for determining the degree of confirmation in this case will be explained with reference to FIG. 6B. Reference numerals 621, 622, and 623 shown in FIG. 6B are queries of tracking information. Circles shown in FIG. 6 are the feature amounts of one person within one frame, and the feature amounts are arranged according to time series.

For example, in determining the degree of confirmation by using 621 as a tracking information query, the degree of similarity between a most recent feature amount 624 of the tracking information query 621, a most recent feature amount 625 of the tracking information query 622, and a most recent feature amount 626 of the tracking information query 623 are respectively calculated. Subsequently, the average of the degree of similarity in each feature amount is calculated as in Formula 4 below.

$$\begin{matrix}[ Formula 4 ] & \\ {similarity}_{other} = \frac{{\sum }_{i = 1}^{n - 1} F ( {f}_{self} , {f}_{i} )}{n - 1} & ( 4 )\end{matrix}$$

However, it is assumed that similarityₒₜₕₑᵣ in the above Formula 4 is the average of the degree of similarity of feature amounts between tracking information queries. “n” is the number of queries for all the tracking information. It is assumed that f_{self} denotes the most recent feature amount of the tracking information query being paid attention to, “fᵢ “denotes the most recent feature amount of the other tracking information query, and “i” denotes a subscript that is different for each of tracking information queries. For example, a value obtained by “subtracting similarityₒₜₕₑᵣ” of the similarity average from 1 is determined to be the degree of confirmation, and when the degree of confirmation is higher than a predetermined threshold, tracking information being paid attention to is included in the combination. Thus, a tracking information query being paid attention to and the other tracking information are compared, and as a result, it is possible to perform a person collation at a timing when the similarity of image features between persons is low. According to this method, there is an advantage of suppressing false collations in addition to significantly enabling the reduction of the amount of calculation in a person collation.

Note that the combination determination unit 270 can also determine the degree of confirmation based on both the comparison between the feature amounts in the tracking information query explained above and the comparison between the feature amounts between the tracking information queries. Specifically, when the similarity between the feature amounts in the tracking information query is high and the similarity between the feature amount in the tracking information query and the feature amount in the other tracking information query is low, the combination can be determined so as to include this tracking information.

An example of calculating the degree of confirmation will be explained with reference to FIG. 6B. First, the degree of similarity between the most recent feature quantity 624 in the query 621 of the tracking information query being paid attention to and a past feature quantity 627 is calculated by the above Formula 3. Next, the degree of similarity between the most recent feature amounts of the query 621 of the tracking information being paid attention to, the query 622 of tracking information, and the query 623 of tracking information that are other tracking information are calculated by the above Formula 4. In addition, for example, the degree of confirmation is set to a value obtained by subtracting “similarity_{self}” that is the degree of similarity between the feature amounts in the query of the tracking information by “similarityₒₜₕₑᵣ” that is the degree of similarity between the feature amount of the query of the tracking information and the feature amount of the query of the other tracking information.

Thus, according to the method based on both the comparison between the feature amounts in the tracking information queries and the comparison of feature amounts between the tracking information queries, the calculation amount increases slightly compared to the method based only on the latter one, however, false collations can be suppressed while significantly reducing the calculation amount in a person collation.

Note that when a part of the range of the detection region of the most recent frame of tracking information is hidden, the combination determination unit 270 may forcibly lower the degree of confirmation. Specifically, a tracking information query in which the detection region in the most recent frame overlaps between a plurality of persons lowers the degree of confirmation. This is because when a plurality of persons enter the image range of the detection region, the image features of a plurality of persons are included in a single feature amount, and because the probability of confirmation is low even when a person collation is performed. For example, the presence or absence of overlap is determined by comparing the magnitude relation between the xy coordinates at one end point of a rectangle and the xy coordinates at another end point of the other rectangle with respect to two detection regions. According to this method, the amount of calculation performed by the combination determination unit 270 can further be reduced, more than the method based on the degree of similarity described above.

Note that although it has been described above that the person collation unit 240 performs a person collation based on image features in the detection region, the method of person collation is not limited to this method. A method using face recognition may be used. In this method, the person collation unit 240 performs face detection within the image range of a person associated with the tracking information and applies a model of face authentication that is prepared in advance to the image range of the detected face.

The face authentication model is a model in which a different ID for each person is output when an image including a face is input. The face authentication model is applied to the detection region of a face of each tracking information, and when the result of face authentication acquired from the tracking information associated with the person information matches the result of face authentication result acquired from the query of the tracking information, person information corresponding to the corresponding tracking information is determined. Since the method using face authentication is based on information that is certainly different for each person, the accuracy of the result of person collation is higher, compared to the other methods.

Note that although it has been described above that the display control unit 250 outputs information related to the tracking information or the person information for each frame, the processing of the display control unit 250 is not limited to this. For the person corresponding to the tracking information in which the person information has not been determined for a certain period of time, the reason why the person information has not been able to be determined may be displayed (text information is displayed). For example, the information of “person collation is not performed because there is no significant movement” is displayed around this person. According to this method, a user can know the reason why the person information regarding the person in the video image is not easily determined.

Although it has been explained, in the above described embodiment, that the combination determination unit 270 determines the combination by limiting the tracking information query based on the degree of confirmation, in a new embodiment to be described below that is different from the above, the person information to be collated is also further limited.

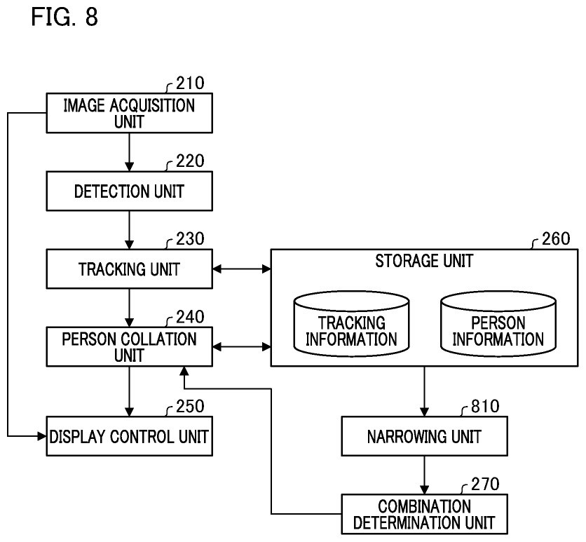

FIG. 8 is an example of a block diagram showing a functional configuration of the information processing apparatus 100 according to the present embodiment. In the present embodiment, a narrowing unit 810 is added as a new component. Since other components are similar to those in the embodiments described above, redundant description will be omitted.

The narrowing unit 810 performs processing for narrowing down candidates of person information corresponding to the tracking information query from among items of the person information in which collation has not been established. In the present embodiment, the narrowing unit 810 narrows down the candidates of the person information corresponding to the query of the tracking information based on the comparison between the feature amount of the query of the tracking information and the feature amount of the tracking information associated with the person information, and further performs association between the query of the tracking information and the candidates. Hereinafter, the information in which the tracking information query and the candidate of person information have been associated will be referred to as “association information”. The narrowing unit 810 transfers the association information to the combination determination unit 270. The combination determination unit 270 determines a tracking information query of the collation target based on the degree of confirmation, and further determines the person information to be collated based on the association information.

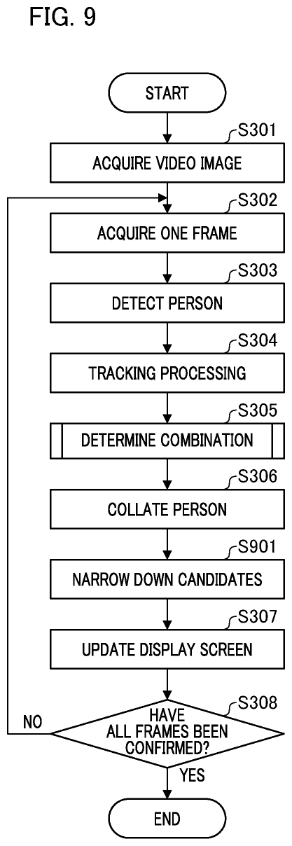

The flow of process in the present embodiment will be explained with reference to FIG. 9. FIG. 9 is a flow chart that explains the processing of the information processing apparatus 100 in the present embodiment. Note that the processing according to the present embodiment differs from the processing according to the above-described embodiment on the point that the processing performed by the narrowing unit 810 is added and on the point that the content of processing performed by the combination determination unit 270 is changed. Note that a detailed description of the same processing as that in FIG. 3 explained above will be omitted.

Through the explanation of the processing for the frame at time tₘ as shown in FIG. 4, it will be shown that the narrowing unit 810 narrows down the person information corresponding to the tracking information query. Next, through the explanation of the processing for the frame at time tₙ, it will be shown that the combination determination unit 270 determines the combination of collation target by using the result of the processing performed by the narrowing unit 810.

First, the processing at time tₘ will be explained. In the present embodiment, as in the above disclosure, it is assumed that processing is performed on the other images before processing is performed on the video images as shown in FIG. 4, and the information has already been stored in a database at this point in time. Additionally, in the present embodiment, it is assumed that, at time tₘ, a database of person information shown in FIG. 5B has already been stored in the storage unit 260. Although a detailed description regarding the table shown in FIG. 5 will be omitted because it has been described as above, personal information of person2, person3, and person4 in which collation has not been established is present in the database. It is assumed that the frame at time tₘ is the frame immediately after persons B and C frame in.

First, in S301, the image acquisition unit 210 acquires the video image as shown in FIG. 4. Next, in S302, the detection unit 220 acquires the image 420 (acquires one frame in the video image). Next, in S303, the detection unit 220 performs processing for detecting a person from the image 420. Next, in S304, the tracking unit 230 performs tracking processing by using information on the detection region in which the detected person is present. At this time, tracking information queries tracks 8 and 9 corresponding to person B and person C are generated by the tracking unit 230.

Next, in S305, the combination determination unit 270 determines the combination of collation target. The process in S305 in the present embodiment is carried out through the process flow in FIG. 3B, as in the above. However, at time tₘ, since the person B and the person C have just been framed in, it is not possible to compare the feature amounts of the frames before time tₘ and the feature amount of the most recent frame, and thus the calculation of the degree of confirmation in S3053 by the method as described above cannot be done. Here, the degree of confirmation is forcibly set to 1 in the case in which comparison to the previous frame is impossible, and the query of the tracking information being paid attention to is included in the combination of collation target. Additionally, the combination determination unit 270 determines the tracking information query track8 and the tracking information query track9 corresponding to the person B and the person C, and all the person information of the person 2, the person 3, and the person 4 for which collation has not been established, to be the combination of collation target.

Next, in S306, the person collation unit 240 performs a person collation. Here, the degree of similarity between the feature amounts of the tracking information query and tracking information associated with the person information is calculated, and when there is a combination exceeding a predetermined threshold, the person information corresponding to the tracking information query is determined. However, in the present embodiment, unlike the embodiment explained above, when there is a plurality of items of person information in which the degree of similarity is high in comparison to a tracking information query, processing that does not determine the person information is performed. For example, regarding a tracking information query, the presence or absence of person information in which the degree of similarity exceeds a predetermined threshold is confirmed. When the corresponding person information is present and the number of items of the person information is one, the person information corresponding to the tracking information query is determined. If two or more items of the corresponding person information are present, the person information is not determined.

Next, in S901, the narrowing unit 810 determines the candidate of human information corresponding to a tracking information query in which the person information has not been determined. In the present embodiment, the narrowing unit 810 determines the candidate of human information, based on the degree of similarity between the feature amount of the tracking information query and the feature amount having the tracking information associated with person information in which collation has not been established.

Specifically, the narrowing unit 810 uses the degree of similarity calculated in S306. For example, when a plurality of items of person information in which the degree of similarity exceeds a predetermined threshold is present with respect to a tracking information query, the person information that corresponds to this tracking information query is determined to be a candidate. Subsequently, the narrowing unit 810 stores the association information of the tracking information query and the candidate of human information in the storage unit 260.

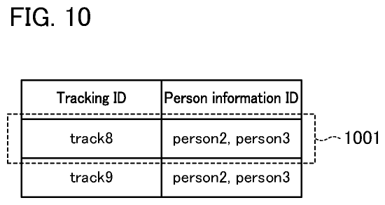

FIG. 10 is a diagram that explains the association information that the narrowing unit 810 generates. A dotted region 1001 shown in FIG. 10 shows that person information of the person 2 and person 3 are associated with the tracking information query track8 as a candidate.

Referring back to FIG. 9, next, in S307, the display control unit 250 updates the screen using the method similar to the method as described above. Next, in S308, the CPU 101 determines whether or not a series of processes has been completed for all the frames. As the result of determination, when a series of processes has been completed for all the frames in the video image, the processing ends. In contrast, when a series of processes has not been completed for all the frames in the video image, the process returns to S302, and processes from S302 to S308 are repeated.

The above is an explanation of the processing on the image 420 (frame) at time tₘ. It has been explained above that the narrowing unit 810 narrows down the candidates of person information corresponding to the tracking information query, from among items of person information in which collation has not been established. Next, the processing on the image 430 (frame) at time tₙ will be explained, and the method in which the combination determination unit 270 determines the combination of collation target based on the degree of confirmation and the association information will be described. As described above, although, at time tₘ, both the person B and the person C turn backward, at time tₙ, only the person B turns sideways.

First, processes from S302 to S304 are performed as in the processing at time tₘ. Next, in S305, the processing performed by the combination determination unit 270 will be explained in detail by referring to FIG. 3B.

First, in S3051, the combination determination unit 270 obtains lists of tracking information queries. Next, in S3052, the combination determination unit 270 selects one tracking information query. Next, in S3053, the combination determination unit 270 calculates the degree of confirmation with respect to the tracking information query that has been selected in S3052. Next, in S3054, whether or not the degree of confirmation has been calculated with respect to all the tracking information queries acquired in S3051 is determined. If the degree of confirmation has not been calculated from all the acquired tracking information queries, the process returns to S3051 and the same processes are repeated. If the degree of confirmation has been calculated from for all the acquired tracking information queries, the process proceeds to S3055. By the processing to this stage, in the present embodiment, it is assumed that, in the tracking information query track8 corresponding to person B, a degree of confirmation is obtained that is high in comparison to the tracking information query track9 corresponding to the person C is obtained, as in the above.

Next, in S3055, the combination determination unit 270 determines the combination of collation target. In the present embodiment, the combination determination unit 270 determines a tracking information query to be collated based on the degree of confirmation, and further determines person information to be included in the combination based on the tracking information query and the association information. Here, the combination determination unit 270 determines including the tracking information query track 8 in the combination of collation target, by a method that is the same as in the method described above.

Next, the combination determination unit 270 refers to the association information shown in FIG. 10 and determines including the person information person 2 and person 3, as the candidates of person information associated with the tracking information query track8, in the combination of collation target. Accordingly, the combination determination unit 270 determines tracking information query track8 and person information person 2 and person 3 to be a combination of collation target. In contrast, the tracking information query 9 is not included in the combination of collation target. In the combination determination unit 270, the person collation unit 240 transfers the information on combination. When the processing up to this stage is completed, the process returns to S306 in FIG. 9.

Next, in S306, the person collation unit 240 performs a person collation by using the tracking information query included in the combination and the person information in which collation has not been established. In the present embodiment, it is assumed that person information person 2 is determined to correspond to the tracking information query track8.

Next, in S307, the display control unit 250 updates the display screen by a method similar to the method as described above. Finally, in S308, the CPU 101 determines whether or not a series of processes has been completed for all the frames. As the result of determination, when a series of processes has been completed for all the frames in the video image, the processing ends. In contrast, when a series of processes has not been completed for all the frames in the video image, the process returns to S302, and processes from S302 to S308 are repeated.

The above is an explanation regarding the processing for the frame at time tₙ. By the processing explained up to this stage, the narrowing unit 810 can narrow down the candidates of person information corresponding to the tracking information query, and the combination determination unit 270 can appropriately determine a combination of collation target based on the degree of confirmation and the association information.

As described above, the information processing apparatus 100 in the present embodiment can limit the number of items of person information to be included in the combination of collation target by performing the processing as described above by using the configuration including the narrowing unit 810, and thereby the amount of calculation in person collation can further be reduced.

Note that, in the above description, although the method in which the narrowing unit 810 determines the candidate of person information corresponding to the tracking information query based on the similarity of the feature amount of the tracking information query for the previous frames and the feature amount of person information has been explained, the method for determining the candidates is not limited to this method. For example, the narrowing unit 810 can also narrow down the candidates based on information regarding crossings of persons in the video image. Specifically, the occurrence of crossings of persons in the video image is detected based on a plurality of items of tracking information, and tracking information related to the crossing is estimated. Then, person information corresponding to the tracking information query associated before the occurrence of the crossing, as a candidate, relative to the tracking information associated with the crossing after the occurrence of crossing, is narrowed down.

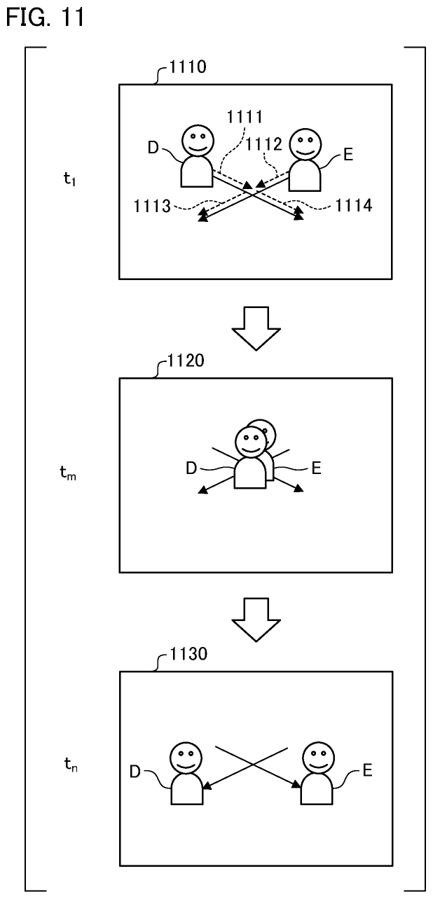

An example of processing in this case will be explained with reference to FIG. 11. FIG. 11 is a diagram that explains video images handled in a modified example of the present embodiment. The image 1110 shown in FIG. 11 is a frame at time t₁. Additionally, the image 1120 is a frame at time tₘ. Additionally, the image 1130 is a frame at time tₙ. Note that the video image in FIG. 11 is a video image that is different from the video image in FIG. 4.

In the video image as shown in FIG. 11, person D and person E move in the direction shown by a solid arrow from time t₁, and person D and person E cross at time tₘ. The dotted arrow shows the path of movement of the person who is being chased by tracking information generated by the tracking unit 230. Due to the occurrence of this crossing, the tracking information corresponding to the person D is segmented as shown by tracking information 1111 and tracking information 1114 corresponding to the person D. Furthermore, tracking information corresponding to the person E is also segmented as shown by a dotted arrow 1112 and a dotted arrow 1113. Note that it is assumed that, regarding the tracking information 1111 and the tracking information 1112, the corresponding person information has been determined prior to time tₘ.

The narrowing unit 810 first detects the occurrence of crossing. The occurrence of crossing is detected based on, for example, the positional relation of detection region based on the feature amounts that a plurality of items of tracking information has. Specifically, the distance between the center position of the detection region of this tracking information and the center position of the detection region of the other tracking information is calculated for each frame so that the occurrence of crossing is detected (checked) regarding a given item of tracking information. Then, when there is a frame in which the distance is less than a predetermined threshold, it is determined that a crossing has occurred at the time corresponding to that frame.

In the example as shown in FIG. 11, it is assumed that a crossing has been detected in a frame at time tₘ based on the positional relation of the detection region from tracking information 1111 to tracking information 1114. The narrowing unit 810 determines a candidate of the person information corresponding to the query of the tracking information based on the information indicating that the tracking information 1111 and 1112 are related to the crossing before the crossing has occurred and the tracking information 1113 and 1114 are related to the crossing after the crossing has occurred. Here, the narrowing unit 810 determines that the candidate of the person information corresponding to the query 1113 of tracking information and the query 1114 of tracking information related to after the occurrence of crossing is the person information related to the tracking information 1111 and the tracking information 1112 related to prior to the occurrence of crossing.

Thus, the narrowing unit 810 can narrow down candidates for person information based on the tracking information associated with the crossing. According to this method, the person information can appropriately be narrowed down even at the time when a crossing occurs.

Note that although it has been explained as above that the combination determination unit 270 determines the combination of collation target based on the association information and the degree of confirmation, the method for determining the combination is not limited to this. For example, it is possible to determine a combination of collation target based on the degree of confirmation and the association information, and then determine a tracking information query and person information not included in that combination to be a separate new combination.

For example, it has been explained above that the combination determination unit 270 determines the tracking information query track8, person information person 2 and person 3 to be a combination of collation target. However, the remaining tracking information query track9 and the remaining person information person4 for which collation has not been established may be determined to be a separate new combination. Thus, after a combination is determined, the combinations that remains are determined, and the person collation is performed on each of them, so that the person collation is performed after dividing into combinations that have a high probability of determining the person information with respect to a tracking information query, and consequently, the number of unnecessary person collations can further be reduced.

Note that it is assumed that, in the combination determination unit 270, a plurality of tracking information queries associated with a given item of person information is present in the association information. In this case, when person information is determined for at least one tracking information query, the remaining tracking information query associated with the same candidate may be the next collation target. This is because when person information corresponding to the tracking information query of a similar person is determined, the probability in which person information corresponding to the other tracking information query can be determined increases.

For example, with respect to the result of the calculation of the degree of similarity during the person collation as shown in FIG. 7, the narrowing unit 810 determines that the candidates of the person information in both the tracking information query track8 and the tracking information query track9 are person information person2 and person3. In addition, it is assumed that the combination determination unit 270 has determined the tracking information query track8 and the tracking information query track9 and the person information person2 and person3 to be the combination of collation targets.

Subsequently, when the person collation unit 240 determines that the person information corresponding to the tracking information query track8 is the person information person2, and in the next loop, the combination determination unit 270 sets the tracking information query track9 to the collation target in the next loop. According to this method, regarding the remaining tracking information query associated with the same candidate, it is possible to omit the processing of calculating the degree of confirmation performed by the combination determination unit 270.

As explained above, according to the information processing apparatus 100 in the present embodiment, the number of times of collation can be reduced and the amount of calculation can be reduced by determining the combination of collation target corresponding to the person in the video image before the collation.

The information processing apparatus 100 in the present embodiment is particularly effective in the following case. That is, this is a case in which the person information corresponding to the person in the video image cannot be determined even if a person collation is performed on the person in the video image over a plurality of frames. This case can occur, for example, when a plurality of items of person information regarding a person wearing similar clothing is present in the database. In the prior art, there is a concern that the amount of calculation increases because, in the case in which the above-described case occurs, collation processing is repeatedly performed on the same person in the video image. According to the information processing apparatus 100 in the present embodiment, a reduction in calculation amount in such cases can be expected.

Although the preferred embodiment of the present invention has been described as shown above, the present invention is not limited to these embodiments, and various modifications and changes are possible within the scope of its gist. For example, among the functional blocks as shown in FIG. 2, a portion of the functional blocks may be included in an apparatus that is different from the information processing apparatus 100. More specifically, a storage device, which is different from the information processing apparatus 100, may have the function of the storage unit 260, and the function of the present embodiment may be realized by a communication between the information processing apparatus 100 and the storage device based on wired or wireless connection. Similarly, one or a plurality of functional blocks in FIG. 2, such as the tracking unit 230, the person collation unit 240, and/or the combination determination unit 270, may be realized by one or a plurality of computers that is different from the information processing apparatus 100. Additionally, the information processing apparatus 100 may have an image capture function. In this case, for example, the information processing apparatus 100 may have a photographing unit and the detection unit 220, and one or a plurality of devices that is different from the information processing apparatus 100 may have functions other than the detection unit 220 in FIG. 2, or the information processing apparatus 100 may have an image capture function in addition to all the functions in FIG. 2. The same applies to FIG. 8.

The present invention can also be realized by processing in which a program that realizes one or more functions of the above embodiments is supplied to a system or device via a network or storage medium, and one or more processors in the computer of the system or device read and execute the program. In that case, the program and the storage medium storing the program configure the present invention. In addition, the present invention can also be realized by a circuit (for example, an ASIC) that provides one or more functions.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-071955, Apr. 25, 2022, which is hereby incorporated by reference wherein in its entirety.

What is claimed is:

1. An information processing apparatus comprising:
one or more memories storing instructions; and
one or more processors executing the instructions to:
determine tracking information that is a target of collation processing for performing association with person information, from among a plurality of items of tracking information corresponding to a plurality of persons detected from a video image frame, based on a feature amount of each of the persons, and
execute collation processing in which person information to be associated with the tracking information that is a target of the collation processing is identified, based on a similarity between a feature amount of a person corresponding to a tracking information determined to be a target of the collation processing and a plurality of feature amounts stored in association with a plurality of items of person information in a storage device.

2. The information processing apparatus according to claim 1,
wherein, among the plurality of items of tracking information, tracking information in which association with person information has already been completed is excluded from a target of the collation processing.

3. The information processing apparatus according to claim 1,
wherein the one or more processors determine tracking information to be a target of the collation processing based on a difference between a first image feature of each of the plurality of persons in a first video image frame and a second image feature of each of the plurality of persons in a second video image frame photographed later than the first video image frame.

4. The information processing apparatus according to claim 3,
wherein, from among the plurality persons, the one or more processors determine tracking information on a person, in which a difference between a first image feature in the first video image frame and a second image feature in the second video image frame is a threshold or above is determined to be a target of the collation processing.

5. The information processing apparatus according to claim 4,
wherein the one or more processors do not set tracking information of a person, from among the plurality of persons, in which a difference between a first image feature in the first video image frame and the second image feature in a second video image frame is less than a threshold to a target of the collation processing.

6. The information processing apparatus according to claim 1,
wherein if person information to be associated with a tracking information that is a target of the collating processing is identified by the collating processing, the one or more processors associates the identified person information and the tracking information that is a target of the collating processing.

7. The information processing apparatus according to claim 5,
wherein if first person information is identified to be person information to be associated with tracking information of a first person that has been detected in a first video image frame by the collation processing, the one or more processors associate the first person information and first tracking information corresponding to the first person, and do not perform collation processing for the first tracking information to be updated in a second video image frame photographed later than the first video image frame.

8. The information processing apparatus according to claim 1,
wherein the one or more processors determine tracking information to be a target of the collating processing based on a similarity of feature amounts between the plurality of persons.

9. The information processing apparatus according to claim 1,
wherein the one or more processors perform the collation processing based on a similarity between the feature amount of a person corresponding to tracking information determined to be a target of the collation processing and the feature amount associated with the person information.

10. The information processing apparatus according to claim 1,
wherein the one or more processors narrow down a candidate of person information to be used in collation processing of the person in a second video image frame photographed later than the first video image frame based on a comparison between the feature amount of a person corresponding to tracking information determined to be a target of the collation processing in the first video image frame and the plurality of feature amounts stored in the storage device in association with a plurality of items of person information.

11. The information processing apparatus according to claim 10,
wherein the one or more processors determine data of a feature amount to be used for collation processing for the tracking information that has been detected from the second video image frame based on a result of the narrowing.

12. The information processing apparatus according to claim 10,
wherein if a crossing of the person in the video image is detected, the one or more processors execute collation processing for tracking information in association with the crossing after the crossing occurs, by using the person information corresponding to tracking information in association with the crossing before the crossing occurs.

13. The information processing apparatus according to claim 1,
wherein the one or more processors determine a combination of tracking information to be a target of the collation processing and a feature amount to be a comparison target to a feature amount of the tracking information from among the plurality of feature amounts stored in the storage device, and determine tracking information and person information not included in the combination as another combination for the collation processing.

14. The information processing apparatus according to claim 1,
wherein if the one or more processors determine that tracking information of the first person is to be associated with the first person information after determining performing the collation processing based on feature amounts of each of a first person and a second person that have been detected from a video image frame and a feature amount associated with first person information and second person information stored in the storage device, the one or more processors execute collation processing based on a feature amount associated with the second person information and a feature amount of the second person without executing collation processing based on a feature amount associated with the second person information and a feature amount of the first person.

15. The information processing apparatus according to claim 1,
wherein the one or more processors cause a display unit to display at least one of the tracking information and the person information together with the video image frame.

16. The information processing apparatus according to claim 15,
wherein the one or more processors cause at least one of numerical value indicating information on the person, a character indicating a reason why the collation processing for the person has not been completed, and a frame surrounding the person to be displayed on an area surrounding the person to be displayed on the display unit.

17. A control method of an information processing apparatus comprising:
determining tracking information that is a target of collation processing for associating with person information, from among a plurality of items of tracking information corresponding to a plurality of persons detected from a video image frame based on a feature amount of each of the plurality of persons, and
executing collation processing in which person information to be associated with the tracking information that is a target of the collation processing is identified based on a similarity between a feature amount of a person corresponding to the tracking information determined to be a target of the collation processing and a plurality of feature amounts stored in association with a plurality of items of person information in a storage device.

18. A non-transitory computer-readable storage medium storing a program for causing a computer to execute a control method of an information processing apparatus, the method comprising:
determining tracking information that is a target of collation processing for performing association with person information from among a plurality of items of tracking information corresponding to a plurality of persons detected from a video image frame based on a feature amount of each of the plurality of persons, and
executing collation processing in which person information to be associated with the tracking information that is a target of the collation processing is identified based on a similarity between a feature amount of a person corresponding to the tracking information determined to be a target of the collation processing and a plurality of feature amounts stored in association with a plurality of items of person information in a storage device.
